(19) United States
(12) Patent Application Publication
(10) Pub. No.: US 2023/0047182 A1
(43) Pub. Date: Feb. 16, 2023

(54) A METHOD FOR IMPROVING DURABILITY AND WEATHERABILITY OF TIMBER BY ENGINEERING LAYERS

(71) Applicant: ABODO WOOD LIMITED, Auckland (NZ)

(72) Inventors: Benjamin Jeremy Rowland CAMPBELL, Auckland (NZ); Daniel Jon GUDSELL, Auckland (NZ)

(73) Assignee: ABODO WOOD LIMITED, Auckland (NZ)

(21) Appl. No.: 17/785,642

(22) PCT Filed: Dec. 18, 2020
(86) PCT No.: PCT/NZ2020/050178

§ 371 Date: Jun. 15, 2022

(30) Foreign Application Priority Data
Dec. 19, 2019 (NZ) 760411

(51) Int. Cl. B32B 21/04; B32B 7/12; B32B 21/13; B32B 21/14; B32B 37/12; B32B 37/20; B32B 38/00; B32B 38/14; B32B 38/18

(52) U.S. Cl. CPC B32B 21/042; B32B 7/12; B32B 21/13; B32B 21/14; B32B 37/12; B32B 37/20; B32B 38/0036; B32B 38/14; B32B 38/1833; B32B 2250/03; B32B 2307/4026; B32B 2317/16; B32B 2419/00

(57) ABSTRACT

The invention relates to a method of manufacturing high durability timber product, the method comprising: a) selecting a durable substrate timber; b) selecting a veneer of high-performance timber; and c) gluing the veneer of high-performance timber to the face of the durable substrate 5 timber, wherein the resulting manufactured high durability timber product is suitable for long-term use in exterior applications at a lower cost than that of the same thickness timber product if made of high-performance timber alone.

### FIELD OF INVENTION

The invention relates to a method of increasing the durability and weatherability of timber. More particularly, the invention relates to a method of increasing the durability and weatherability of timber by laminating a veneer of high-performance timber to a dimensionally stable and durable substrate timber.

### BACKGROUND OF THE INVENTION

Timber properties can vary greatly depending on the source of timber, the cut of the timber and treatment of the timber. For example, softwood species including radiata pine (“radiata”), southern yellow pine, scots pine, ash, maple, beech, birch, aspen and rubber wood when used in exterior applications have disadvantages including lack of dimensional stability in service (“stability”), surface hardness, surface checking/cracking and poor colour/aesthetics following exposure. The use of preservatives and timber modification techniques are known ways for increasing weatherability. Such timber is predominantly flat sawn, due to the ease of production and log diameter.

Flat sawn or rotary peeled timber is one of the most efficient ways of breaking down a log. However, such timber can contain imperfections such as core heartwood, flat grain and/or knots which reduces the quality and stability of the final timber product. Grain orientation in timber can have a large impact on the weatherability of wood in exterior applications. As timber dries, different contractions occur depending upon the orientation of the cut made to produce the timber and the resulting grain orientation. It is known that in exterior applications wood typically cracks perpendicular to the grain. Boards with a flat grain orientation are known to be prone to splitting and surface checking when used in exterior applications, while boards with a vertical grain orientation are more resistant to warping, splitting and surface checking and are thus more stable.

Flat sawn or rotary peeled timber is used in a number of exterior applications such as decking, screening, structural timber and cladding. However, flat sawn and rotary peeled timbers have disadvantages including surface checking when used in exterior applications. Surface checking typically occurs perpendicular to the grain and the cracks are known to harbour moisture and can lead to premature failure of the wood and/or coatings applied to the wood. This has led to flat sawn or rotary peeled timber being unable to compete in some market applications with expensive high-performance exterior timbers that are more durable and do not crack. This is especially the case where high-quality finishes, such as a smooth surface, are required. Consequently, flat sawn and rotary peeled timber is viewed as a low-value, lower quality timber for exterior applications. However, the high-performance exterior timbers that do not crack are generally more expensive and/or are limited in supply.

To improve the stability of timber, it is known to laminate individual boards together of the same or similar material. Laminated wooden boards are typically produced by gluing together individual boards in a flat grain orientation edge-to-edge or face-to-face to give individual finished boards with a flat or mixed grain orientation. However, lamination in this way typically results in finished boards of flat grain orientation that are more prone to surface checking and movement. This occurs as the timber expands and contracts when it gets wet, causing the wood fibres to pull apart in some places. It can result in reduced long-term durability performance, as the cracks allow water to enter the timber potentially leading to fungal decay. It is also a disadvantage in terms of aesthetics. There is a market preference for high value wood products that do not crack, as the cracking detracts from the visual appearance.

Movement can also cause delamination of the glue lines and premature failure of the timber. It also results in unsightly glue lines in the finished product (see, for example, the lamination technique shown in New Zealand Patent No. 562263).

Wood veneer surface laminates known in the art are typically only semi- or non-durable and are primarily designed for interior use. Examples of such products are flooring boards made with three-layer construction (a hardwood veneer top layer, middle layer and bottom layer made of a softwood such as untreated spruce) and other layer laminated products. Such veneer laminates do not typically provide long term durability or stability in exterior applications.

Therefore, durable solid timber is generally used in exterior applications, whether preserved or naturally durable. This therefore increases the cost of the build, or reduces the instances where such timber would otherwise be used in a build, and also places strain on the growth, harvesting and supply of these timbers, especially when they are slow growing, or have limited growing areas, and or need to be imported.

The method of the present invention utilises stable and durable substrates in combination with a high-performance timber surface layer (veneer). The veneer is less prone to cracking and restricts surface checking. This enhances long term durability, aesthetics and reduces cost.

It is an object of the invention to provide a method of manufacturing a laminated timber product to restrict surface checking/cracking and enhance the long-term durability of the timber in exterior applications. Alternatively, it is an object of the invention to at least provide a useful choice to the public.

### SUMMARY OF THE INVENTION

According to a first aspect of the invention, there is provided a method of manufacturing a high durability timber product, the method comprising:
a) selecting a durable substrate timber;
b) selecting a veneer of high-performance timber; and
c) gluing the veneer of high-performance timber to the face of the durable substrate layer,

wherein the resulting manufactured high durability timber product is suitable for long-term use in exterior applications at a lower cost than that of the same thickness timber product if made of high-performance timber alone.

Preferably the durable substrate is a timber that is stable and durable in exterior use.

In one particular embodiment, the durable substrate is flat sawn or rotary peeled timber.

In one embodiment, the durable substrate is dressing grade, merchantable grade or standard grade. In one embodiment, the substrate is finger jointed or solid form.

In a particular embodiment, the substrate is a naturally durable timber such as eucalyptus, western red cedar, yellow cedar, larch, teak or other timber with minimum Class 3 durability (EN350) or equivalent.

In a particular embodiment, the substrate is a non-durable timber such as Pinus species (pine), Douglas fir, poplar, or rubber wood that has been thermally modified with or without preservative treatment.

In a particular embodiment, the substrate is preservative treated or modified for durability. In one embodiment, the substrate is non-durable timber such as Pinus species, Douglas fir, poplar, or rubber wood that has been preservative treated. In one embodiment the preservative treatment is Light Organic Solvent Preservative (LOSP), Copper Quaternary, Alkaline copper quaternary (ACQ), Chromated copper arsenate (CCA) minimum UC3A (American Wood Protection Association—AWPA), water based azoles, optionally with added insecticide and/or water repellent, Micronized Copper Azole (MCA), copper naphthenate or equivalent.

Construction of the durable substrate may be solid, finger-jointed, laminated, plywood, cross laminated or laminated veneer lumber (LVL). In one embodiment, the substrate may be a board (6), panel (7) or post (8).

Preferably, the veneer is a high-performance, stable, durable timber that is unlikely to crack in exterior conditions.

In one embodiment, the veneer of high-performance timber comprises stable naturally durable timber such as western red cedar, eucalyptus, kwila/merbau, teak, Cypress, Paulownia, thermally modified oak, thermally modified beech, spotted gum and thermally modified ash.

In one embodiment, the veneer of high-performance timber described herein comprises substantially vertical grain timber. In one embodiment, the substantially vertical grain timber is quarter sawn. In one embodiment, the veneer of high-performance timber is laminated with substantially vertical grain orientation so that the veneer has the appearance of a vertical grain on the face of timber but is made from substantially flat grain timber. In one embodiment the veneer described herein is a non-durable timber such as Pinus radiata.

In one embodiment, the veneer of high-performance timber comprises flat grain, rift sawn, crown cut and/or mixed grain timber.

In one embodiment, the veneer of high-performance timber described herein comprises a non-durable timber such as Pinus species, Spruce, Beech, Ash, Douglas Fir, Rubberwood, Poplar, Cedar, Cork, that has been modified to increase its stability, durability and performance in exterior conditions. In one embodiment, the modification is selected from:

thermal modification, densification, thermo-mechanical densification, acetylation, furfylation, resin impregnation, Dimethyloldihydroxyethelenurea (DMDHEU) modification, alkaline copper quaternary (ACQ) modification, copper azole treatment and/or combinations thereof.

In one embodiment, the veneer of high-performance timber is thermally modified. In one particular embodiment the veneer of high-performance timber is thermally modified substantially vertical grain Pinus radiata or Pinus radiata timber laminated with substantially vertical grain orientation. In one embodiment the thermally modified vertical grain timber is quarter sawn.

In another embodiment, the veneer is thermally modified Pinus radiata laminated with vertical grain orientation. The thermally modified vertical grain veneer can be timber that has the appearance of a vertical grain on the face of the timber that is made from substantially flat grain timber.

In another aspect, the veneer of high-performance timber is thermally modified acetylated timber. In one embodiment, the veneer of high-performance timber is thermally modified acetylated radiata pine.

Optionally, the veneer of high-performance timber is further treated with a preservative such as a solvent or water borne azole and/or an insecticide such as synthetic pyrethroids, neonicotinoids or boron. Optionally, the veneer of high-performance timber is not treated with any chemical preservative and/or insecticide.

In another embodiment, the veneer of high-performance timber described herein comprises a further modification selected from: thermal modification, densification, thermo-mechanical densification, acetylation, furfylation, resin impregnation, Dimethyloldihydroxyethelenurea (DMDHEU) modification, alkaline copper quaternary (ACQ) modification, copper azole treatment and/or combinations thereof.

In a particular embodiment, the veneer of high-performance timber is resistant to fire, with a minimum ASTM E84 Class A, AS3959 BAL29 (Australian Standard 3959), and/or EN 13501-1 Euro Class B (European Standard 13501-1).

In one embodiment, the veneer of high-performance timber is a board or panel.

In a particular embodiment, the veneer of high-performance timber has a thickness of about 1 mm to 10 mm. Preferably, the veneer has a thickness of about 1 mm, 1.5 mm, 2 mm, 2.5mm, 3 mm, 3.5 mm, 4 mm, 4.5 mm, 5 mm, 5.5 mm, 6 mm, 6.5 mm, 7 mm, 7.5 mm 8 mm, 9 mm or 10 mm.

In a particular embodiment the substrate is thermally modified pine plywood and the veneer of high-performance timber is thermally modified vertical grain wood. In a particular embodiment the substrate is thermally modified pine plywood and the veneer of high-performance timber is acetylated pine. In a particular embodiment the substrate is thermally modified radiata pine and the veneer of high-performance timber is acetylated pine. In a particular embodiment the substrate is thermally modified radiata pine and the veneer of high-performance timber is vertical grain cedar.

In one embodiment, the substrate is thermally modified radiata pine and the veneer of high-performance timber is acetylated radiata pine; the substrate is thermally modified pine plywood and the veneer of high-performance timber is thermally modified vertical grain wood, thermally modified radiata pine laminated with vertical grain orientation, macrocarpa, spotted gum, eucalyptus, resin impregnated radiata pine or vertical grain western red cedar; the substrate is CCA treated radiata pine posts and the veneer of high-performance timber is thermally modified radiata pine laminated with vertical grain orientation; the substrate is a thermally modified radiata pine exterior grade plywood panel and the veneer of high-performance timber is thermally modified radiata pine laminated with vertical grain orientation; the substrate is ACQ treated radiata pine laminated veneer lumber and the veneer of high-performance timber is ACQ treated kiln dried quarter sawn radiata pine; the substrate is thermally modified flat sawn dressing grade radiata pine and the veneer of high-performance timber is thermally modified acetylated radiata pine; the substrate is thermally modified flat sawn dressing grade radiata pine and the veneer of high-performance timber is resin impregnated radiata pine (impregnated with a mix of melamine resin and fire retardant); the substrate is thermally modified flat sawn dressing grade radiata pine cross laminated and the veneer of high-performance timber is band sawn thermally modified radiata pine laminated with vertical grain orientation; or the substrate is thermally modified radiata pine and the veneer of high-performance timber is vertical grain cedar. In one embodiment, the substrate it thermally modified pine and the veneer of high-performance timber is thermally modified beech.

The veneer of high-performance timber and/or substrate may be further coloured by the use of UV stable pigments that can be imparted to the timber surface by pressure impregnation, spray or dip either on its own or as part of a preservative treatment process. This pigment acts both to further protect the timber from the effects weathering including ultraviolet light and to maintain the colour of the timber by delaying the ‘silvering off’ effect.

In one embodiment, the method of the invention comprises laminating a veneer of high-performance timber of 1 mm to 10 mm thick high-performance timber to the face of predominantly flat sawn or rotary peeled pine (or similar timber) either preservative-treated or modified for durability.

In one particular embodiment, the veneer of high-performance timber is laminated to the face of solid, finger-jointed, laminated, plywood, cross-laminated or laminated veneer lumber (LVL) substrate timber. In one particular embodiment, the veneer of high-performance timber is laminated to the face of a board, beam, panel or post substrate timber. In one particular embodiment, veneer of high-performance timber boards are face laminated edge to edge to the outside face of substrate panels. In one embodiment, the veneer of high-performance timber is laminated to the outside faces of a post substrate.

In one embodiment, the timber product is cross-laminated. In one particular embodiment, the timber product comprises three layers: a top veneer of high-performance timber as described herein and two layers of the substrate as described herein, wherein the middle substrate layer is positioned at 90 degrees to the top veneer layer and the bottom substrate layer to form a cross laminated timber panel. In one embodiment, the layers of the cross-laminated product are face glued using melamine adhesive in the three-layer construction.

Preferably, the veneer of high-performance timber is glued to the substrate. In one embodiment the glue layer is a high-performance exterior-type glue, such as polyurethane, melamine, melamine urea, phenolic or resorcinol adhesives. Preferably, the glue layer between the veneer of high-performance timber (surface layer) and the substrate is heat or fire resistant. Preferably the glue has a colour similar to that of the substrate.

In one embodiment, a glue lamination plant is used to glue the substrate and veneer as a double up (substrate-veneer-substrate). The double up is then cut in half by bandsaw to create 2 pieces. These pieces can then be moulded to provide a profile suitable for the end use application including weatherboard cladding, shiplap, tongue and groove, square dressed, rhombus, decking or screening with band sawn, brushed, textured or smooth dressed faces.

In a particular embodiment, a traditional glue lamination plant is used to glue the surface veneer onto the substrate to all four sides to form a structural beam/post.

In an alternative embodiment, the method can be performed by panel pressing of the surface layer (veneer) onto the substrate using a hot or cold veneer press. In another alternative embodiment, the method can be performed using an engineered flooring plant. In still another alternative embodiment, the surface layer (veneer) can be pressed onto the substrate using a vacuum or mechanical press.

In one particular embodiment, the timber product is treated after lamination with a modification such as densification, thermo-mechanical densification, acetylation, furfylation, resin impregnation, Dimethyloldihydroxyethelenurea (DMDHEU) modification, alkaline copper quaternary (ACQ) modification, copper azole treatment and/or combinations thereof. In one embodiment, the timber product is treated after lamination with a preservative such as a solvent or water borne azole and/or an insecticide such as synthetic pyrethroids, neonicotinoids or boron.

According to a second aspect of the invention, there is provided a manufactured timber product comprising a veneer and a substrate wherein:
a. the substrate is cut by flat saw or rotary peel;
b. the veneer is a high-performance timber that is unlikely to crack in exterior conditions; and
c. the veneer is glued to the face of the substrate,

wherein the resulting timber product is suitable for long-term use in exterior applications at a lower cost than that of the same thickness timber product if made of high-performance timber alone.

In one embodiment, the timber product is suitable for the end use application including weatherboard cladding, shiplap, tongue and groove, square dressed, rhombus, decking or screening. In one embodiment, the timber product may be a board, panel or post.

In one embodiment, the timber product is a cladding or decking board of about 140×18 mm, about 140×27 mm or about 90×20 mm dimension or about 180×20 mm (width×height). In one embodiment, the timber product is a cladding or decking board of about 70-290×20-32 mm or a panel of about 15-25 mm thick×600-1200 mm width×2400-6000 mm length.

In one embodiment, the timber product comprises band sawn, brushed, textured or smooth dressed faces.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features prefaced by that term in each statement all need to be present, but other features can also be present. Related terms such as “comprise” and “comprised” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

To those skilled in the art to which the invention relates, many changes in construction and widely differing embodiments and application of the invention will suggest themselves without departing from the scope of the invention as defined in the appended claims. The disclosures and the descriptions herein are purely illustrative and are not intended to be in any sense limiting.

Further aspects of the invention, which should be considered in all its novel aspects, will become apparent to those skilled in the art upon reading of the following description which provides at least one example of a practical application of the invention.

### BRIEF DESCRIPTION OF THE DRAWINGS

Embodiments of the invention will now be described, by way of example only, with reference to the accompanying drawings in which:

FIG. 1 shows cross section of a tree showing growth rings/grain orientation (5) and showing the timber cuts (9) sawn from a tree with flat grain A, vertical grain C, rift sawn B and mixed grain D,

FIG. 2 shows cross section of a tree showing growth rings/grain orientation (5) and showing common types of sawmilling timber cuts (9) on the cross section of a log, flat sawn is shown in A, quarter sawn is shown in B and rift sawn is shown in C,

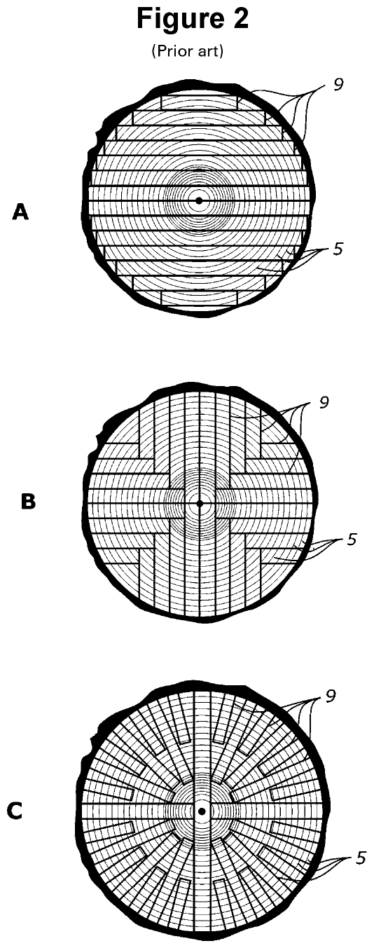

FIG. 3 shows thermally modified flat sawn radiata pine board after weathering and exhibiting cracking (4), (FIG. 3A shows a photograph while FIG. 3B shows graphic representation of the photograph to highlight details such as wood grain (5) and cracking (4)),

FIG. 4 shows thermally modified flat sawn radiata pine board after approximately 2 months weathering and exhibiting cracking (4) (FIG. 4A shows a photograph while FIG. 4B shows graphic representation of the photograph to highlight details such as cracking (4)),

FIG. 5 shows a timber product of the invention (10). A board (6) with high-performance acetylated radiata pine veneer (2) on thermally modified radiata pine base (1) (FIG. 5A shows a photograph while FIG. 5B shows graphic representation of the photograph to highlight details such as glue lines (3), wood grain (5) and cracking (4)),

FIG. 6 shows an example of preparing a timber product (10) of the invention, including: Step 1—laminating two substrate boards (1) to the veneer (2); Step 2—splitting the veneer (1) down the middle; and Step 3—moulding the resulting board to a tongue and groove profile,

FIG. 7 shows a timber product of the invention (10). Boards (6) comprising an acetylated radiata pine veneer (2) laminated onto flat sawn TM radiata pine substrate and weathered for approximately 12 months (FIG. 7A shows a photograph while FIG. 7B shows graphic representation of the photograph to highlight details such as the veneer (2)),

FIG. 8 shows a timber product of the invention (10). Decking boards (6) with laminated vertical grain TM radiata pine face laminated onto thermally modified flat sawn radiata pine substrate (FIG. 8A shows a photograph while FIG. 8B shows graphic representation of the photograph to highlight details such as the veneer (2) and wood grain (5)),

FIG. 9 shows a timber product of the invention (10). Cladding boards (6) with mixed veneers (2) laminated on flat sawn TM radiata pine substrate and weathered for approximately 3 years (FIG. 9A shows a photograph while FIG. 9B shows graphic representation of the photograph to highlight details such as the veneer (2)),

FIG. 10 shows a timber product of the invention (10). A post (8) comprising laminated vertical grain thermally modified veneer (2) laminated onto glue-laminated CCA-treated radiata pine substrate (1) (FIG. 10A shows a photograph while FIG. 10B shows graphic representation of the photograph to highlight details such as the veneer (2), substrate (1) and wood grain (5)),

FIG. 11 shows a timber product of the invention (10). An engineered beam with laminated vertical grain thermally modified radiata pine veneer (2) face laminated on all sides to CCA treated laminated pine substrate (1) after weathering, demonstrating that the CCA substrate exhibits cracking (4) and the laminated vertical grain TM radiata pine veneer does not have cracks (FIG. 11A shows a photograph while FIG. 11B shows graphic representation of the photograph to highlight details such as the veneer (2), substrate (1), glue lines (3), grain (5) and cracking (4)),

FIG. 12 shows a timber product of the invention (10). A high-performance thermally modified radiata pine veneer laminated with vertical grain (2) and face laminated to thermally modified radiata pine plywood veneer (1), weathered for approximately 18 months (FIG. 12A shows a photograph of the timber product, FIG. 12B shows a detailed cross section of the timber product and FIG. 12C shows graphic representation of the photographs 12A and 12B to highlight details such as the veneer (2), substrate (1), and glue lines (3)),

FIG. 13 shows a timber product of the invention (10). A high-performance quarter sawn ACQ treated radiata pine veneer (2) laminated onto ACQ LVL substrate (1) and profiled into exterior decking, weathered for approximately two years (FIG. 13A shows a photograph while FIG. 13B shows graphic representation of the photograph to highlight details such as the veneer (2), substrate (1), glue lines (3) and grain (5)),

FIG. 14 shows a timber product of the invention (10). A high-performance acetylated thermally modified radiata pine veneer (2) onto thermally modified pine substrate (1) and profiled into decking boards, weathered for approximately 6 months (FIG. 14A shows a photograph while FIG. 14B shows graphic representation of the photograph to highlight details such as the veneer (2), substrate (1), glue lines (3) and grain (5)),

FIG. 15 shows a timber product of the invention (10). A high-performance acetylated thermally modified radiata pine veneer (2) onto thermally modified pine substrate (1) and profiled into decking boards, of FIG. 14, weathered for approximately 6 months (FIG. 15A shows a photograph while FIG. 15B shows graphic representation of the photograph to highlight details such as the veneer (2), substrate (1), glue lines (3), grain (5) and cracks (4)),

FIG. 16 shows a timber product of the invention (10). A high-performance resin impregnated radiata pine veneer (2) onto thermally modified pine substrate (1), weathered for approximately 1 year (FIG. 16A shows a photograph while FIG. 16B shows graphic representation of the photograph to highlight details such as the veneer (2), substrate (1), glue lines (3) and grain (5)),

FIG. 17 shows a timber product of the invention (10). A high-performance resin impregnated radiata pine veneer (2) onto thermally modified pine substrate (1), weathered for approximately 1 year (FIG. 17A shows a photograph while FIG. 17B shows graphic representation of the photograph to highlight details such as the veneer (2), substrate (1), glue lines (3) and grain (5)), and

FIG. 18 shows a timber product of the invention (10). Boards (6) with laminated vertical grain thermally modified radiata pine veneer (2) onto thermally modified pine cross laminated timber substrate (1) (FIG. 18A shows a photograph while FIG. 18B shows graphic representation of the photograph to highlight details such as the veneer (2), substrate (1), glue lines (3) and grain (5)).

### DETAILED DESCRIPTION

### Definitions

“Softwood” means wood from gymnosperm trees. Gymnosperms reproduce by forming cones which emit pollen to be spread by the wind to other trees. Pollinated trees form naked seeds which are dropped to the ground, borne on the wind, or otherwise carried so that new trees can grow elsewhere. Some examples of softwood include cedar, pine, redwood, Douglas fir, cypresses, spruce and larch.

“Hardwood” means wood from angiosperm trees. Angiosperms produce seeds with some sort of covering such as a shell or a fruit. Angiosperms usually form flowers to reproduce. Birds and insects attracted to the flowers carry the pollen to other trees and when fertilized the trees form fruits or nuts and seeds. Hardwoods include eucalypts, beech and blackwood.

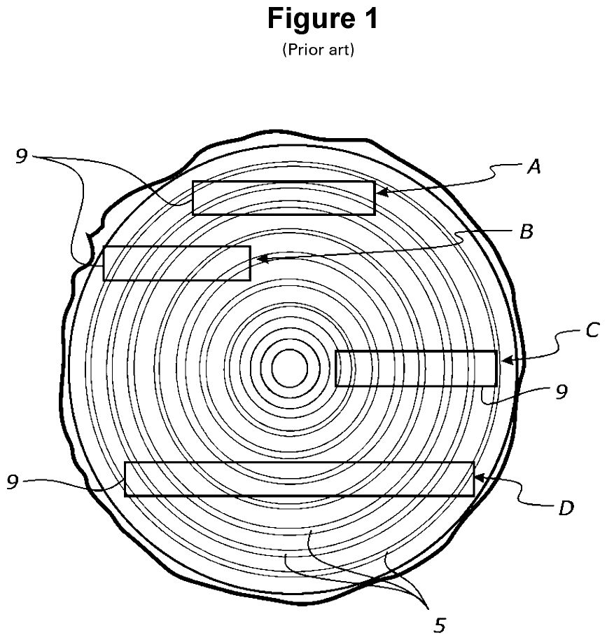

A “board” is defined as a piece of timber sawn from a tree with a width greater than a depth, and a length greater than the width. The face of the board is defined as a plane with edges defined by the width and the length of the board. A cross sectional view of the board through the width and depth axis will typically be substantially rectangular, though it may also have edge detail to allow joining for example tongue and groove, and may also be sloped on one or more major surfaces or edge surfaces to form weather boards or similar. Boards may be cut from the tree in a variety of orientations as shown in FIG. 1 and described in further detail below.

“Plywood” is defined as a wooden board comprising two, three or more layers of wood veneer glued and pressed together with veneers positioned with grain at 90-degree angle to each other.

“Laminated veneer lumber” is defined as a wooden board comprising three or more layers of wood veneer glued and pressed together with veneers positioned parallel to each other.

“Veneer” means a thin layer of wood from about 1 mm to about 10 mm thick. The veneer may optionally be adhered to a surface.

“Dimensional stability” or simply “stability” means the degree of resistance to deformation, expansion or shrinkage that can result from changes in conditions such as temperature and humidity.

“Weatherability” means the degree of cracking, checking, distortion, splintering or otherwise degrading in exposure to an exterior application.

“High-performance” means a greater degree of resistance to cracking, movement, checking, distortion, splintering, or otherwise degrading. The timber may additionally be high-performance because it is resistant to fire or because it has high dimensional stability, increased hardness or toughness.

“Durable” means the degree of resistance to decay as a result of fungal or microorganism growth and degradation, and optionally the degree of resistance termite attack.

“EN350” refers to the European standards for durability of wood and wood-based products. The durability classes of wood-based materials to attack by fungi are split into 5 classes: Class 1—Very durable; Class 2—Durable; Class 3—Moderately durable; Class 4—Slightly durable; Class 5—Not durable.

“Aesthetic characteristics” means the visual appearance of the timber, taking into account the colour, texture, presence of glue lines, contrast between lamination layers and grain orientation.

“Dressing grade” means a mid-quality grade of timber which can contain some tight knots and small defects along with some timber without knots.

“Merchantable grade” means a lower-quality grade of timber that can contain many knots and large defects

“Standard grade” means a mid-quality grade of timber that contains tight knots.

“Finger jointed” means pieces of timber with or without knots or defects that have been profiled with an interlocking shape at the ends and joined together with glue to form a longer length of timber.

The present invention is directed to a method for manufacturing timber product (10) to improve the durability and weatherability of what would otherwise be a lower quality exterior timber. The inventors have developed a method of processing flat sawn and rotary peeled timber to yield a product with enhanced weathering performance, durability and stability when compared to other exterior timber products, including other laminated products currently published or on the market. An advantage of this method is the ability to mimic or exceed the weatherability characteristics of more expensive exterior timber. The method is applicable to modify any species to impart more desirable durability, hardness or aesthetic properties. In particular embodiments, the timber is selected from rotary peeled or flat sawn timber.

The inventors surprisingly found the timber product of the invention (10) to be suitable for use in long term external applications. Long term external applications include placement of the timber product where some part or all of the timber product is exposed to the outdoors/weather for 2, 3, 6, 12, 18, 24 or more months. In one embodiment, the timber product of the invention (10) is suitable for use in an external application for greater than 12 months, greater than 18 months or greater than 24 months.

Some methods of obtaining higher performance exterior timbers, such as by rift sawing or quarter sawing, can result in a large amount of wastage during production. The processes of flat sawing and rotary peeling are the most efficient ways of breaking down a log. However, flat sawn and rotary peeled timber has a lower value than other cuts of timber and lacks the durability of high-performance exterior timber. It can contain imperfections such as core heartwood, flat grain and/or knots which reduces the quality and stability of the final timber product. In exterior applications such timber is often cast aside as off-cuts in favour of the naturally more higher performance timber, such as vertical grain, or is further processed to remove imperfections. Flat sawn and rotary peeled timber is less weatherable as it often suffers from surface checking when used in exterior applications. Surface checking typically occurs perpendicular to the grain and the cracks are known to harbour moisture. This can lead to premature failure of the wood and/or coatings applied to the wood.

The present inventors have tested different methods to mitigate the drawbacks of using flat grain and rotary peeled timber, and found that these drawbacks can be effectively addressed by adding a high-performance veneer (2) to the flat sawn or rotary peeled substrate (1); in particular when the high-performance veneer is applied to a durable, but lower cost substrate. The inventors have found that the veneer (1) holds the face of the base substrate (2) together, substantially reducing cracking (4) and extending the service life of wood and coatings. This forms a synergistic combination of durable but relatively cheap low-grade substrate (1) with (more expensive) high-performance timber top veneer (1). The inventors have therefore provided a solution to the problem of using cheaper, lower grade, rotary peeled/flat sawn timber in place of more desirable expensive exterior timbers, but with the same weathering performance in the finished product.

Production of flat sawn and rotary peeled timber for use in exterior applications is limited due to its disadvantages including surface checking in exterior applications, the need to process the wood and the cost this adds to the final product. For high throughput timber operations this is undesirable and adds cost to what is a commodity product. The inventors have recognised that there may be market for products produced from flat sawn and rotary peeled timber. From an economic point of view, the upgrading of lower value materials to higher value products is desirable. The invention therefore provides the user with a method of extracting more value from a finite resource and contributing to the sustainable use of land and forests.

Use of flat sawn or rotary peeled timber in exterior applications does have some advantages particularly over expensive high-performance exterior timbers. These advantages typically relate to efficiency, cost and environmental concerns. High-performance exterior timbers that do not crack are generally more expensive or limited in supply. Flat sawing or rotary peeling are the most efficient ways of breaking down a log. Other methods of breaking down a log are inefficient and create varying degrees of waste during production. For example, although rift sawing results in a high value substantially vertical grain timber it creates a lot of waste during production. The inventors' method of upgrading lower value timber results in a more efficient use of resources and off-cuts.

Accordingly, in a first aspect of the invention, there is provided a method of manufacturing high durability timber product (10), the method comprising:
a) selecting a durable substrate timber (1);
b) selecting a high-performance surface veneer (2); and
c) gluing the high-performance surface layer to the durable substrate layer (3).

One important aspect of the invention is the ability to use flat sawn or rotary peeled timber as the durable substrate in a high durability timber for external use. Flat sawn and rotary peeled timber is generally less valuable and less desirable than other cuts of timber due to its increased tendency for surface checking (cracking (4)) during exterior use. Even when the timber is flat sawn or rotary peeled from a naturally durable wood, or from a non-durable wood and is further processed to increase durability, it can still suffer from the disadvantages outlined above. For example, after thermal modification or Dimethyloldihydroxyethelenurea (DMDHEU), wood fibres of the rotary peeled timber and solid flat sawn timber can become brittle and are prone to surface checking. The inventors have surprisingly found that laminating a durable substrate (1) with a high-performance veneer (2) synergistically increases the dimensional stability, durability and weatherability of the timber. It is not logical, nor is it industry practice, to thermally modify or preserve a piece of wood for durability and stability, then additionally laminate a high-performance layer of wood to the visible face. However, by applying this method, the inventors have found that the resulting timber is higher performance and more durable due to the reduction of surface cracking as the board weathers. As a result of this surface coatings (for example, paint) will also last longer due to the stable top layer.

In one particular embodiment, the durable substrate (1) is flat sawn or rotary peeled timber.

In one embodiment, the durable substrate (1) is dressing grade, merchantable grade, standard grade. In one embodiment, the substrate is finger jointed or solid form.

In one embodiment, the substrate (1) is a naturally durable timber such as eucalyptus, western red cedar, yellow cedar, teak or larch minimum Class 3 durability (EN350) or equivalent.

The substrate (1) may be a modified or preservative treated timber. The use of preservatives and timber modification techniques are known to provide means for increasing the durability of less durable wood, such as softwoods. These techniques are well-known and provide options individually or in combination to increase the durability of less durable wood such as Pinus species, Douglas fir, poplar, and rubber. Examples of suitable preservative treatments include Light Organic Solvent Preservative (LOSP), Copper Quaternary, Alkaline copper quaternary (ACQ), Chromated copper arsenate (CCA) minimum UC3A (American Wood Protection Association—AWPA), water Based Azoles, optionally with added insecticide and/or water repellent, Micronized Copper Azole (MCA), copper naphthenate or equivalent.

The substrate (1) can also be non-durable timber such as Pinus species, Douglas fir, poplar, beech or rubber wood that has been thermally modified. Thermally modified timber exhibits an increase in the stability of the timber. In addition to the increased stability of the timber, the thermal modification process provides a permanent colour change to the timber that penetrates throughout the timber.

Thermally modifying the timber results in timber of increased exterior durability and therefore allows the timber to be used without preservative treatment in many above ground applications. Preferably, the thermal modification is carried out at a temperature of between about 200° C.-260° C. Preferably the temperature is in a range of 200-260° C., or about 250° C., about 240° C., about 230° C., about 220° C., about 210° C., or about 200° C. In some embodiments, the temperature of the thermal modification may be as low as 160° C. The inventors have found that thermally modifying the timber at 200-240° C. imparts durability and stability that provides a suitable product for exterior applications (e.g. cladding, decking) in addition to a medium dark brown colour. Thermal modification at 160° C.-200° C. does provide increased stability but only gives a lighter brown colour.

The duration of treatment at the preferred temperature of 200-240° C. is preferably 2-4 hours, or approximately 3 hours. In some embodiments, the treatment may be from 1-6 hours.

Prior to thermal modification at the temperatures outlined above, the timber is preferably dried to reduce moisture content to substantially 0%. In one embodiment, drying is achieved by the application of heat and optionally steam to heat the timber to 130° C. The duration of the drying step depends on the original moisture content of the timber.

In one embodiment, thermal modification is carried out in a high-pressure cylinder and involves a high-pressure steam treatment of kiln dried timber. Preferably the kiln dried timber has a moisture content of about 16% or less.

A high-pressure cylinder or kiln system that has been specifically designed for the elevated temperatures associated with thermal modification could be used for the thermal modification step. Such thermal modification kilns, as offered, by way of example, by Tekmaheat or Stellac, would be well known to the skilled person in the art. Closed cell thermal modification processes are also suitable for use as a thermal modification process. Such closed cell systems, as offered, by way of example, by Wood Treatment Technology, would be known to those of skill in the art. In one embodiment, closed cell thermal modification is carried out at between 150° C. and 190° C., more preferably 160-180° C.

At 180 to 240° C. the look of Western Red Cedar is achieved. Elevated temperatures can result in a decrease in structural integrity of the timber. Thus, while higher temperatures may result in a more desirable darker colour, the resultant loss of structural integrity dictates the final applications for which the timber can be used. Thermal modification is preferably carried out over a period of between about 2 days and about 4 days, more preferably over 3 days to give a completely coloured and dried product (approximately 6-8% moisture content).

In one embodiment, thermal modification of the timber provides preservative properties to the timber. In particular, the thermally modified wood has increased resistance to degradation by fungi, insects, bacteria and/or algae. The use of thermal modification instead of a chemical preservative compound treatment provides advantages to the user including:
reduced cost of treatment and preservative compounds;
reduced toxicity to animal/human health; and
reduced toxicity to other species and therefore lower environmental impact.

In some situations, for example where the timber may be subject to termite attack, a chemical termiticide such as 3-phenoxybenzyl-(1RS)-cis,trans-3-(2,2-dichlorovinyl)-2,2-dimethylcyclopropane carboxylate (Permethrin) and/or N-[1-[(6-chloro-3-pyridyl)methyl]-4,5-dihydroimidazole-2-yl]nitramide (Imidacloprid) may also be used.

Construction of the durable substrate (1) may be by methods well known to a person skilled in the art, and includes solid, finger-jointed, laminated, plywood, cross-laminated or laminated veneer lumber (LVL). In another embodiment, the substrate (1) may be a board (6), panel (7) or post (8).

In one particular embodiment, the substrate (1) is plywood comprising rotary peeled veneers oriented at right angles to each other and face glued together in a press using exterior grade glue such as phenol formaldehyde.

The inventors have found that laminating a veneer of high-performance timber (2) to the face of a substrate (1) holds the face of the base substrate together, substantially reducing cracking (4) and extending the service life of wood and coatings. In one important aspect of the invention the veneer (2) is a stable, durable, high-performance timber that is unlikely to crack in exterior conditions.

In one embodiment, the veneer of high-performance timber (2) comprises stable naturally durable timber such as western red cedar, eucalyptus, kwila/merbau, teak, cypress, Paulownia, thermally modified oak, thermally modified beech, spotted gum and thermally modified ash.

In one embodiment, the veneer of high-performance timber (2) described herein comprises substantially vertical grain timber. In one embodiment, the substantially vertical grain timber is quarter sawn. In one embodiment, the veneer of high-performance timber (2) is laminated with substantially vertical grain orientation so that the veneer (2) has the appearance of a vertical grain on the face of timber but is made from substantially flat grain timber. In one embodiment the veneer of high-performance timber (2) described herein is a non-durable timber such as Pinus radiata.

In one embodiment, the veneer of high-performance timber (2) described herein comprises flat grain, rift sawn, crown cut and/or mixed grain timber.

In one embodiment, the veneer of high-performance timber (2) described herein comprises a non-durable timber such as Pinus species, Spruce, Beech, Ash, Douglas Fir, Rubberwood, Poplar, Cedar or Cork, that has been modified to increase its stability, durability and performance in exterior conditions. In one embodiment, the veneer of high-performance timber (2) described herein comprises a modification selected from: thermal modification, densification, thermo-mechanical densification, acetylation, furfylation, resin impregnation, Dimethyloldihydroxyethelenurea (DMDHEU) modification, alkaline copper quaternary (ACQ) modification, copper azole treatment and/or combinations thereof.

In one particular embodiment the veneer of high-performance timber (2) is thermally modified substantially vertical grain radiata pine or radiata pine timber laminated with substantially vertical grain orientation. In one embodiment the thermally modified vertical grain timber is quarter sawn.

In another embodiment, the veneer of high-performance timber (2) is thermally modified radiata pine laminated with vertical grain orientation. The thermally modified vertical grain veneer (2) can be timber that has the appearance of a vertical grain on the face of the timber that is made from substantially flat grain timber. For example, the timber may be produced by the method disclosed in U.S. Pat. No. 10,059,027. In particular, at least two flat-grain thermally modified boards are laminated together by gluing to form a laminated block wherein each original board comprises a laminated layer. The block is then cut substantially perpendicular to the grain to produce individual laminated boards. Each laminated board comprises a front and a back face showing at least one glue line between the laminated layers and said faces have the appearance of a substantially vertical grain orientation. This technique produces boards with glue lines at the join of each original board which extend along the length of the laminated board. Timber processed in this way is more resistant to warping, splitting and surface checking and therefore more stable when used.

FIG. 1 shows the timber sawn from a tree with flat grain A, vertical grain C, rift sawn B and mixed grain D. Each board is cut along a plane defined by the width and depth, the length of board extending along the log; the width of the cuts in FIG. 1 being greater than the depth. The length of the board may be any length. A substantially flat grain orientation means any board with annual rings from 0° to 35° to the edge of the board. A rift sawn board has annual rings from 35° to 65° to the edge of the board and a vertical grain (or quarter sawn) board has annual rings from 65° to 90° to the edge of the board. It will be appreciated by those of skill in the art that the laminated boards with the appearance of vertical grain can be composed of a majority of flat grain timber. However, in certain embodiments, there may be up to 20% of a cross section width of the final laminated boards that is made up of rift sawn or vertical grain timber.

In another aspect, the veneer of high-performance timber is thermally modified acetylated timber. In one embodiment, the veneer is thermally modified acetylated radiata pine.

In one particular aspect, the thermal modification of the veneer of high-performance timber (2) described herein is carried out at a temperature of between about 200° C.-260° C. Preferably the temperature is in a range of 200-260° C., or about 250° C., about 240° C., about 230° C., about 220° C., about 210° C., or about 200° C. In some embodiments, the temperature of the thermal modification may be as low as 160° C. The inventors have found that thermally modifying the timber at 200-240° C. imparts durability and stability that provides a suitable product for exterior applications (e.g. cladding, decking) in addition to a medium dark brown colour. Thermal modification at 160° C.-200° C. does provide increased stability but only gives a lighter brown colour.

The duration of treatment at the preferred temperature of 200-240° C. is preferably 2-4 hours, or approximately 3 hours. In some embodiments, the treatment may be from 1-6 hours.

Prior to thermal modification at the temperatures outlined above, the timber is preferably dried to reduce moisture content to substantially 0%. In one embodiment, drying is achieved by the application of heat and optionally steam to heat the timber to 130° C. The duration of the drying step depends on the original moisture content of the timber.

In one embodiment, thermal modification is carried out in a high-pressure cylinder and involves a high-pressure steam treatment of kiln dried timber. Preferably the kiln dried timber has a moisture content of about 16% or less.

A high-pressure cylinder or kiln system that has been specifically designed for the elevated temperatures associated with thermal modification could be used for the thermal modification step. Such thermal modification kilns, as offered, by way of example, by Tekmaheat or Stellac, would be well known to the skilled person in the art. Closed cell thermal modification processes are also suitable for use as a thermal modification process. Such closed cell systems, as offered, by way of example, by Wood Treatment Technology, would be known to those of skill in the art. In one embodiment, closed cell thermal modification is carried out at between 150° C. and 190° C., more preferably 160-180° C.

At 180 to 240° C. the look of Western Red Cedar is achieved. Elevated temperatures can result in a decrease in structural integrity of the timber. Thus, while higher temperatures may result in a more desirable darker colour, the resultant loss of structural integrity dictates the final applications for which the timber can be used. Thermal modification is preferably carried out over a period of between about 2 days and about 4 days, more preferably over 3 days to give a completely coloured and dried product (approximately 6-8% moisture content).

In one embodiment, the veneer of high-performance timber (2) described herein comprises a modification selected from: thermal modification, densification, thermo-mechanical densification, acetylation, furfylation, resin impregnation, Dimethyloldihydroxyethelenurea (DMDHEU) modification, alkaline copper quaternary (ACQ) modification, copper azole treatment and/or combinations thereof.

Timber can be densified by chemical, mechanical or a combination of chemical and mechanical processes. Chemical densification relies on the filling of spaces in the timber with a fluid, while mechanical densification relies on compression of the wood by applying a mechanical force. Methods for the densification of wood will be well known to a person skilled in the art.

Thermo-mechanically densified timber specifically involves the compression of wood by applying mechanical force and heat. Methods for thermo-mechanically densifying timber will be known to those of skill in the art. In one method, the thermo-mechanical densifying process involves the use of a thermomechanical press, where high temperature platens are contacted with the timber to apply pressure and allow heat transfer.

Timber modification by way of acetylation involves the reaction of a chemical reagent with the wood structural polymeric constituents to result in the formation of a covalent bond between the reagent and the wood substrate. The product obtained contains acetyl groups bonded to hydroxyl (OH) sites in the wood cell wall. Although the reaction can take place using ketene, acetic acid, or acetyl chloride, the most useful process is acetylation of wood due to reaction with acetic anhydride. Methods for the acetylation of wood will be known to those of skill in the art. Acetylated wood is extremely durable and has been improved to the highest EN 350-2 class, class 1 (Sandberg D,. Kutnar A,. Mantanis G, iForest—Biogeosciences and Forestry (2017) 10, Issue 6, Pages 895-908).

Dimethyloldihydroxyethelenurea (DMDHEU) modification involves impregnation of the timber with 1,3-dimethylol-4,5-dihydroxyethyleneurea in a vacuum/pressure process. Optionally, a catalyst such as magnesium chloride (MgCl₂) may also be used. Without being bound by theory, the DMDHEU cross-links with compounds in the wood and undergoes self-polycondensation within the cell wall. This results in permanent bulking of the cell wall which reduces dimensional changes of the wood. Methods for the DMDHEU modification of wood would be well known to a person skilled in the art. DMDHEU is known to improve dimensional stability, weatherability and durability of timber (Militz, H., Schaffert, S., Peters, B. C. et al. Wood Sci Technol (2011) 45: 547).

Furfuryl modified wood undergoes a process known as furfurylation which uses furfuryl alcohol to modify the cell structure of the wood and thereby increase surface hardness, stability and durability. Colour may also be modified by using this technique. Methods to achieve furfurylation of wood are known to those of skill in the art.

Resin impregnation involves using pressure to force organic or non-organic-based resins e.g. melamine, urea formaldehyde, phenol formaldehyde or a combination of urea and starch-based emulsion or pine resin into the wood. This will increase the stability, durability and/or surface hardness characteristics of the timber. Colour may also be modified by using this technique.

In one embodiment, the veneer of high-performance timber (2) comprises timber impregnated by a fire retardant. In one embodiment, the veneer (2) comprises timber impregnated by a mix of melamine resin and a fire retardant.

Optionally, the veneer of high-performance timber (2) described herein is further treated with a preservative such as LOSP, a solvent or water borne azole and/or an insecticide such as synthetic pyrethroids, neonicotinoids or boron. Optionally, the veneer of high-performance timber (2) described herein is not treated with any chemical preservative and/or insecticide.

In one embodiment, the veneer of high-performance timber (2) described herein is resistant to fire, with a minimum ASTM E84 Class A, AS3959 BAL29 (Australian Standard 3959), and/or EN 13501-1 Euro Class B (European Standard 13501-1).

In one embodiment, the veneer (2) timber is a board (6) or panel.

In a particular embodiment, the veneer of high-performance timber (2) has a thickness of about 1 mm to 10 mm. In one embodiment the veneer (2) has a thickness of about 1 mm, 1.5 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 9mm or 10 mm.

The top veneer (2) and/or substrate (1) may be further coloured by the use of UV stable pigments that can be imparted to the timber surface by pressure impregnation, spray or dip either on its own or as part of a preservative treatment process. This pigment acts both to further protect the timber from the effects weathering including ultraviolet light and to maintain the colour of the timber by delaying the ‘silvering off’ effect.

In one embodiment, the method of the invention comprises laminating a veneer of high-performance timber (2) of 1 mm to 10 mm thick to the face of predominantly flat sawn or rotary peeled pine (or similar timber) substrate (1) either preservative-treated or modified for durability.

In one particular embodiment, the veneer of high-performance timber (2) is laminated to the face of solid, finger-jointed, laminated, plywood, cross-laminated or laminated veneer lumber (LVL) substrate timber (1). In one particular embodiment, the veneer of high-performance timber (2) is laminated to the face of a board, panel or post substrate timber (1). In one particular embodiment, veneer of high-performance timber (2) boards are face laminated edge to edge to the outside face of substrate panels (1). In one embodiment, the veneer of high-performance timber (2) is laminated to the outside faces of a post substrate (1).

In one embodiment, the timber product (10) is cross-laminated. In one particular embodiment, the timber product (10) comprises three layers: a top veneer of high-performance timber (2) as described herein and two layers of the substrate (1) as described herein, wherein the middle substrate layer is positioned at 90 degrees to the top veneer layer (2) and the bottom substrate layer to form a cross laminated timber panel. In one embodiment, the layers of the cross-laminated product are face glued (3) using melamine adhesive in the three-layer construction.

Preferably, the veneer of high-performance timber (2) is glued (3) to the substrate (1). Preferably the glue layer (3) is a high-performance exterior type glue, such as polyurethane, melamine, melamine urea, phenolic or resorcinol adhesives. Preferably the glue layer (3) between the veneer of high-performance timber (2) and the substrate (1) is heat or fire resistant. Preferably the glue layer (3) has a colour similar to that of the substrate (1).

The process of lamination in the method of the present invention involves standard techniques which would be known to a person skilled in the art. The person skilled in the art would understand that there are a number of methods for laminating a veneer (2) to a substrate (1).

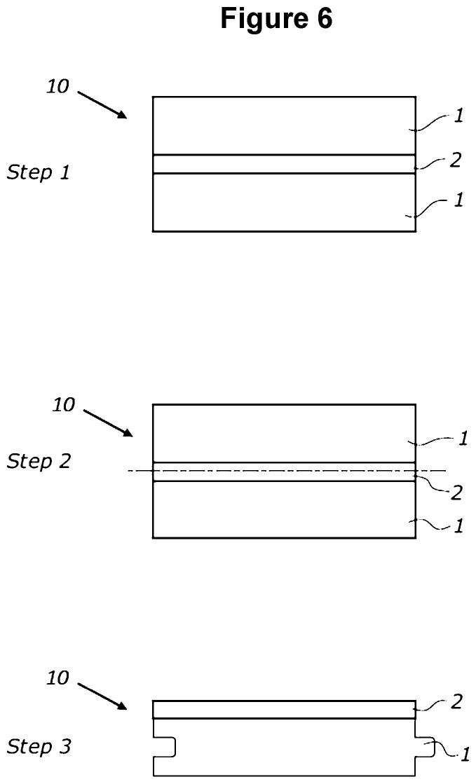

In one embodiment, the method of manufacturing the timber product (10) comprises: Step 1 laminating two substrate timber (1) on to opposite sides of a single veneer of high-performance timber (2); Step 2 splitting the veneer timber (1) down the middle; and Step 3 moulding the resulting timber product into a profile for end use (see FIG. 6).

In one embodiment a glue lamination plant is used to glue the substrate (1) and veneer as a double up (laminating two substrate timber (1) on to opposite sides of a single veneer timber (2)). The double up is then cut in half by a bandsaw to create two pieces (see FIG. 6 step 2). These pieces can then be moulded to provide a profile suitable for end use.

In a particular embodiment, a traditional glue lamination plant is used to glue the veneer onto all four sides of a substrate (1) to form a structural beam/post (8).

Alternatively, panel pressing may be used where the surface veneer of high-performance timber (2) is pressed on to the substrate (1) surface using a hot or cold veneer press, or the process could be performed through an engineered flooring plant, provided appropriate adhesives were used. Alternatively, a cross laminated timber press could be used where the surface layer veneer of high-performance timber (2) is pressed onto the substrate (1) using a vacuum or mechanical press. These pieces can then be moulded to provide a profile suitable for end use.

In one particular embodiment the pieces are moulded to provide a profile suitable for end use application including weatherboard cladding, shiplap, tongue and groove, square dressed, rhombus, decking or screening with band sawn, brushed, textured or smooth dressed faces.

In one particular embodiment, the substrate (1) is thermally modified pine plywood, and the veneer of high-performance timber (2) is thermally modified vertical grain wood. In one particular embodiment, the substrate (1) is thermally modified pine plywood and the veneer of high-performance timber (2) is acetylated pine. In one particular embodiment, the substrate (1) is thermally modified radiata pine and the veneer of high-performance timber (2) is vertical grain cedar.

In one particular embodiment, the timber product is treated after lamination with a modification such as densification, thermo-mechanical densification, acetylation, furfylation, resin impregnation, Dimethyloldihydroxyethelenurea (DMDHEU) modification, alkaline copper quaternary (ACQ) modification, copper azole treatment and/or combinations thereof as described herein. In one embodiment, the timber product is treated after lamination with a preservative such as a solvent or water borne azole and/or an insecticide such as synthetic pyrethroids, neonicotinoids or boron. In a further embodiment, the timber product is treated after lamination with a fire retardant. Post lamination treatment can be used to restrict the resin/modification chemicals to certain areas on the board using the glue lines—in most cases this would be the surface of the wood.

According to a second aspect of the invention, there is provided a manufactured timber product (10) comprising a veneer (2) and a substrate (1) wherein:
a. the substrate is a durable substrate timber (1) cut by flat saw or rotary peel;
b. the veneer (2) is a high-performance timber that is unlikely to crack in exterior conditions; and
c. the veneer is glued to the substrate (1),

wherein the resulting timber product (10) is suitable for long-term use in exterior applications at a lower cost than that of the same thickness timber product if made of high-performance timber alone.

In one embodiment, the timber product is suitable for the end use application including weatherboard cladding, shiplap, tongue and groove, square dressed, rhombus, decking or screening. In one embodiment, the timber product (10) may be a board, panel or post.

In one embodiment, the timber product is a cladding or decking board of about 140×18 mm, about 140×27 mm or about 90×20 mm dimension or about 180×20 mm (width×height). In one embodiment, the timber product is a cladding or decking board of about 70-290×20-32 mm or a panel of about 15-25 mm thick×600-1200 mm width×2400-6000 mm length.

In one embodiment, the timber product comprises band sawn, brushed, textured or smooth dressed faces.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The invention may also be said broadly to consist in the parts, elements and features referred to or indicated in the specification of the application, individually or collectively, in any or all combinations of two or more of said parts, elements or features.

Wherein the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the scope of the invention and without diminishing its attendant advantages. It is therefore intended that such changes and modifications be included within the scope of the invention.

### EXAMPLES

### Example 1—Acetylated Radiata Pine Veneer Onto Thermally Modified Pine Substrate

Flat sawn dressing grade radiata pine in 150×35 mm rough sawn dimension was thermally modified. The thermal modification was carried out at a temperature of about 230 degrees.

The thermally modified pine was then machined to approximately 145×32 mm and cut to remove defects and create clear grade shook of 180 mm-400 mm length using a snip saw. The timber shook was then finger jointed with polyurethane adhesive into the joins.

The 145×32 mm boards were then split down the thickness of the board using a thin kerf bandsaw into approximately 145×15 mm boards.

Acetylated radiata pine of approximately 145×14 mm dimension was placed between two pieces of 145×15 thermally modified radiata pine and was face laminated using polyurethane adhesive.

Once the glue was fully cured, the laminated timber block was split down the middle using a thin kerf bandsaw leaving two pieces of approximately 145×21 mm (see steps 1 and 2 of FIG. 6).

The boards were finally machine dressed on four sides to approximately 140×18 mm decking.

The finished product was installed outside at the applicant's test site in West Auckland, New Zealand on horizontal decking racks facing north and exposed to weather for approximately two years.

### Assessment of Timber

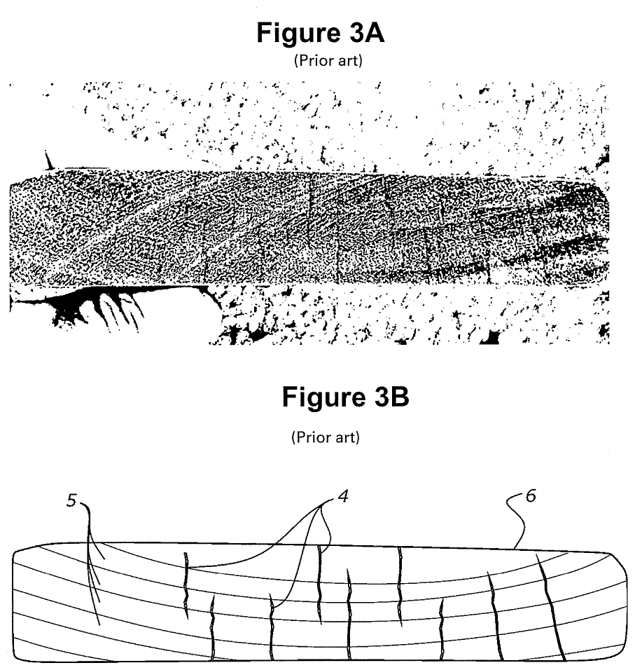

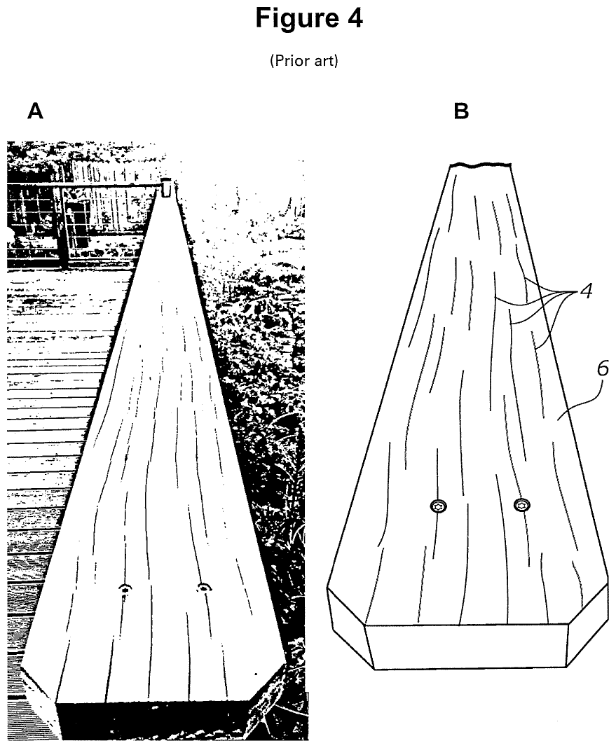

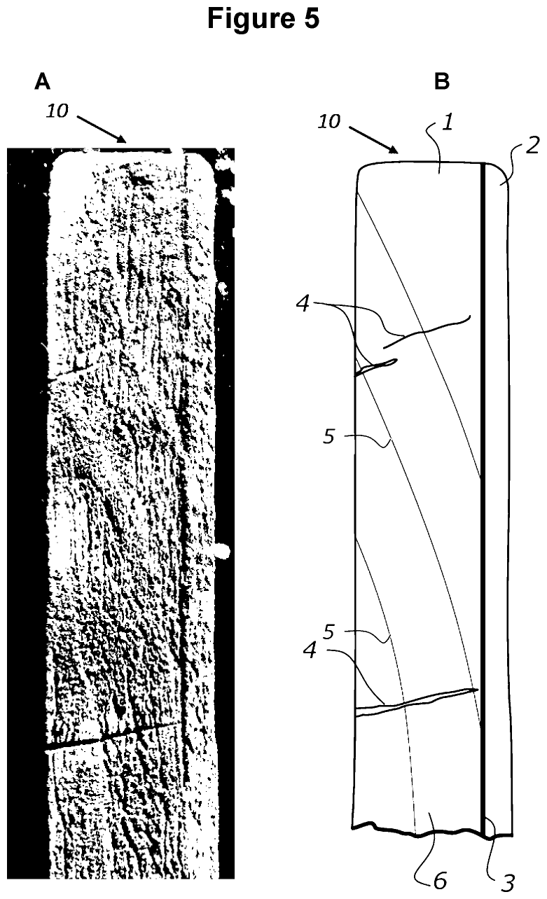

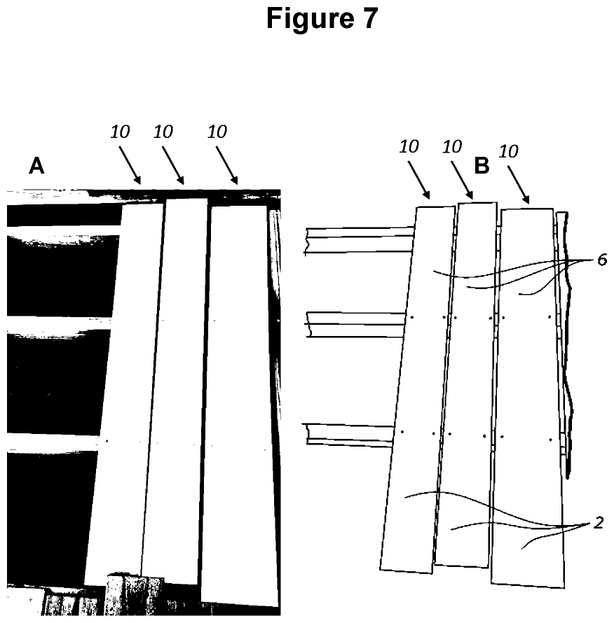

The weathered board (FIGS. 5A, 5B, 7A and 7B) shows reduced or no surface checking when compared with flat sawn thermally modified pine (FIGS. 3A, 3B, 4A and 4B) that exhibits checking on the exposed face.

### Example 2—Mixed Timber Veneers Onto Thermally Modified Pine Substrate

Flat sawn dressing grade radiata pine in 150×35 mm rough sawn dimension was thermally modified. The thermal modification was carried out at a temperature of about 230 degrees.

The thermally modified pine was then machined to approximately 145×32 mm and cut to remove defects and create clear grade shook of 180 mm-400 mm length using a snip saw. The timber shook was then finger jointed with polyurethane adhesive into the joins.

The 145×32 mm boards were then split down the thickness of the board using a thin kerf bandsaw into approximately 145×15 mm boards.

Using a range of timbers, including thermally modified radiata pine laminated with vertical grain orientation, macrocarpa, spotted gum, eucalyptus, resin impregnated radiata pine and vertical grain western red cedar, timber of approximately 145×14 mm dimension was placed between two pieces of 145×15 thermally modified radiata pine and face laminated using polyurethane adhesive.

Once the glue was fully cured, the laminated timber block was split down the middle using a thin kerf bandsaw leaving two pieces of approximately 145×21 mm.

The boards were finally machine dressed on four sides to approximately 140×18 mm tongue and grooved cladding and decking.

The finished product was installed outside at the applicant's test site in West Auckland, New Zealand on horizontal decking racks facing north and exposed to the weather for approximately three years.

### Assessment of Timber

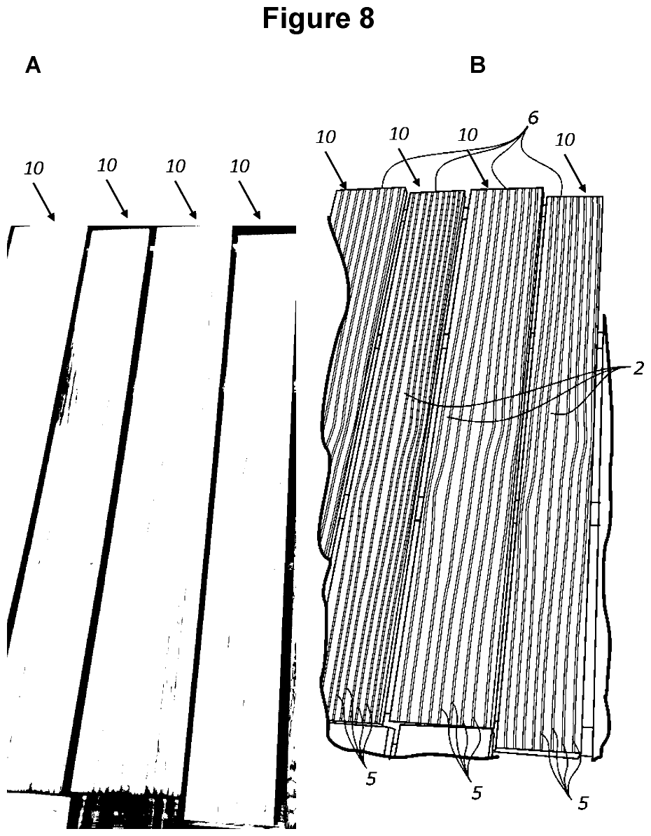

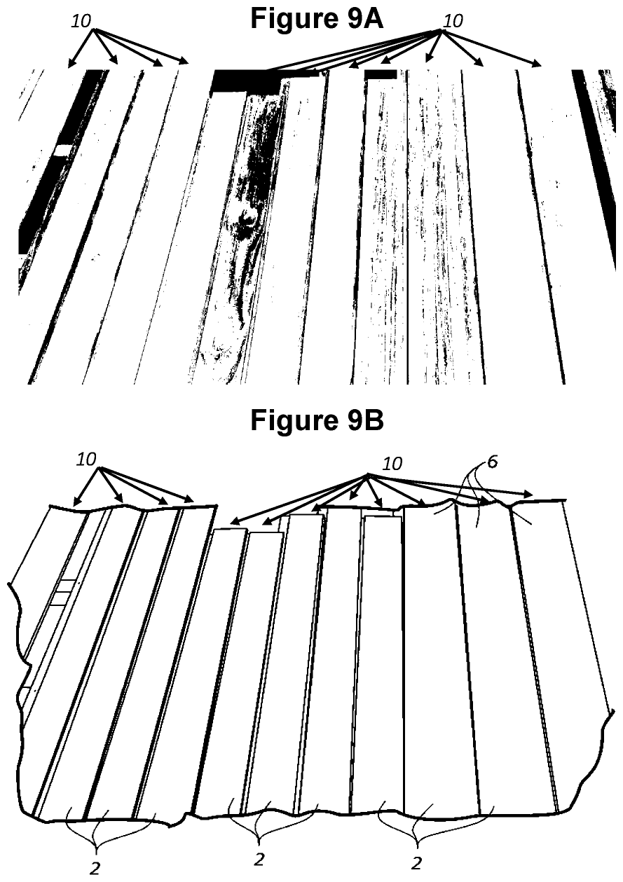

After three years weathering all samples exhibited reduced movement and surface checking (FIGS. 8A, 8B, 9A and 9B) in comparison with flat sawn thermally modified radiata pine

(FIGS. 3A, 3B, 4A and 4B).

### Example 3—Thermally Modified Vertical Grain Pine Onto Laminated CCA Treated Pine Substrate

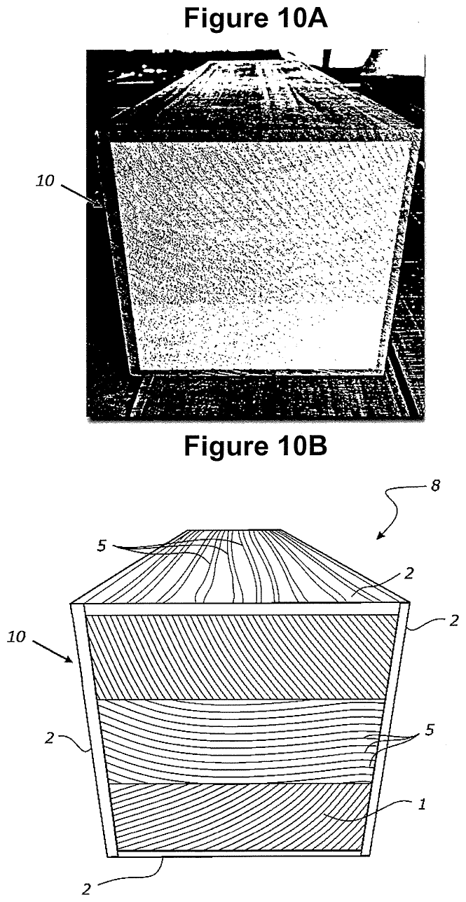

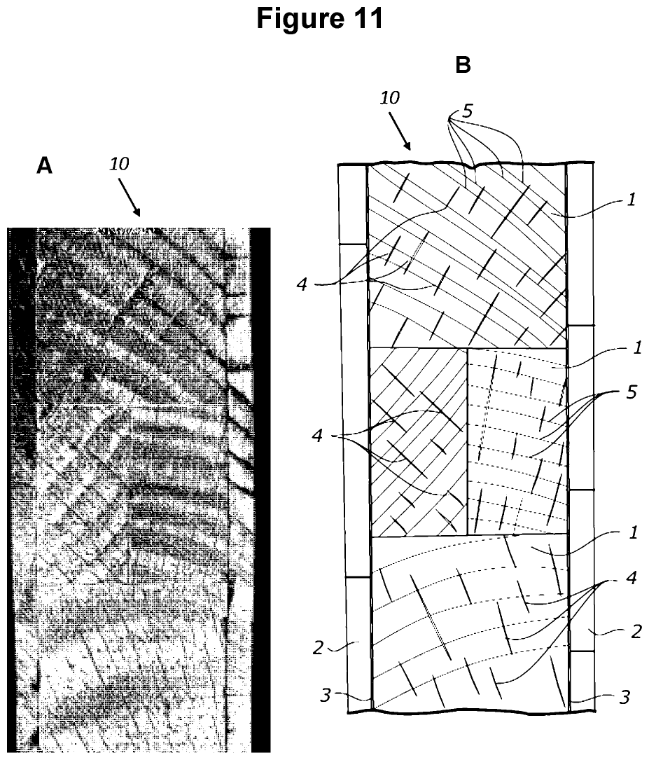

Thermally modified radiata pine laminated with vertical grain orientation of approximately 140×6 mm dimension was face laminated to the outside faces of laminated CCA treated radiata pine posts using a polyurethane adhesive (FIGS. 10 and 11).

Once the glue was fully cured, the laminated timber block was band sawn on four sides in order to clean the faces up.

The finished product was placed outside at the applicant's test site in Auckland, New Zealand on horizontal decking racks and exposed to the weather for approximately 6 months.

### Assessment of Timber

The laminated vertical grain top veneer showed no signs of face cracking, whereas the CCA treated flat sawn pine base material was beginning to crack (FIG. 11A and B).

### Example 4—Thermally Modified Vertical Grain Pine Onto Thermally Modified Plywood Substrate

Boards of band sawn face thermally modified radiata pine laminated with vertical grain orientation of approximately 140×5 mm dimension were face laminated edge to edge to the outside faces of 12 mm thick thermally modified radiata pine exterior grade plywood panels using melamine urea adhesive. The panels were cured under pressure in a cold press.

The finished product was placed outside at the applicant's test site in Auckland, New Zealand on vertical cladding racks and exposed to the weather for approximately two years.

### Assessment of Timber

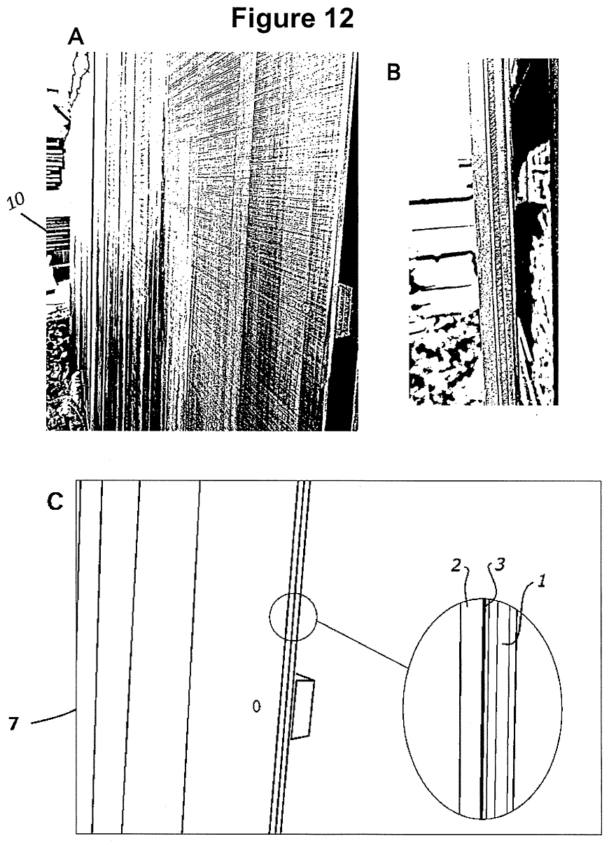

The panels with vertical grain laminated to faces (FIG. 12A, B and C) exhibited less cracking after 18 months than the rotary peeled thermally modified radiata pine panels (FIGS. 3A, 3B, 4A and 4B).

### Example 5—Quarter Sawn ACQ Treated Pine Onto ACQ Treated LVL Substrate

ACQ treated kiln dried quarter sawn radiata pine was machined to approximately 145×20 mm dimension boards.

Two boards of ACQ treated radiata pine laminated veneer lumber (LVL) of approximately 145×20 mm dimension were then face laminated either side of the 145×20 mm quarter sawn ACQ radiata pine board using phenol formaldehyde adhesive to form a block of approximately 145×60 mm. The block was then cured in a hot press in the way familiar to those in the art of plywood manufacture.

Once the glue was fully cured, the laminated timber block was split down the middle of the 60 mm thickness using a thin kerf bandsaw leaving two pieces of approximately 145×30 mm.

The boards were finally machine dressed four sides to approximately 14×27 mm decking.

The finished product was installed outside at the applicants test site in Auckland, New Zealand on a deck facing west and exposed to the weather for approximately two years.

### Assessment of Timber

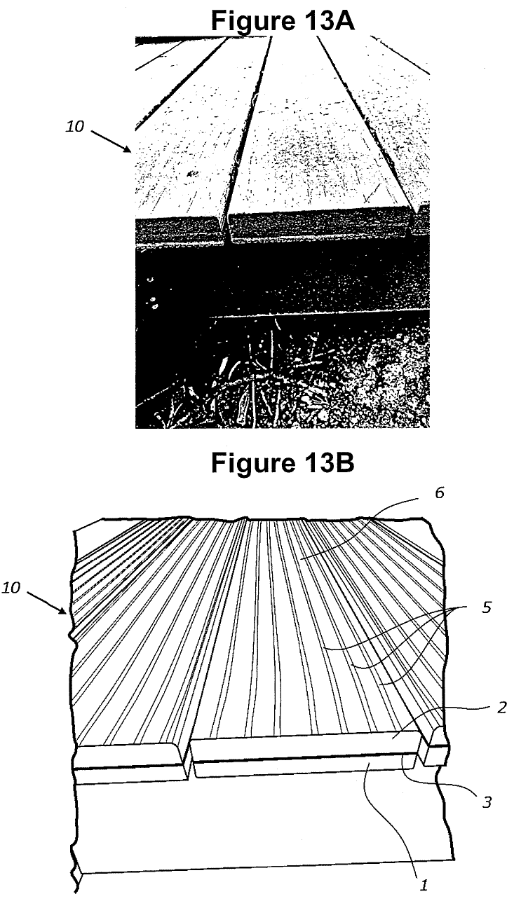

The boards remained flat, straight and exhibited very little/no cracking after weathering for approximately two years (FIG. 13A and B) when compared with rotary peeled or flat sawn radiata pine in the same application.

### Example 6—Acetylated Thermally Modified Radiata Pine Veneer Onto Thermally Modified Pine Substrate

Flat sawn dressing grade radiata pine in 150×35 mm rough sawn dimension was thermally modified. The thermal modification was carried out at a temperature of about 230° C. The thermally modified pine was then machined to approximately 145×32 mm and cut to remove defects and create clear grade shook of 180 mm-400 mm length using a snip saw.

The timber shook was then finger jointed with polyurethane adhesive into the joins. The 145x×32 mm boards were then split down the thickness of the board using a thin kerf bandsaw into approximately 145×15 mm boards.

Acetylated radiata pine of 150×25 mm dimension was thermally modified at 230° C. The acetylated radiata pine timber was cut to 145×14 mm dimension. The acetylated radiata pine timber was then placed between two pieces of 145×15 thermally modified radiata pine and face laminated using polyurethane adhesive.

Once the adhesive was fully cured, the laminated timber block was split down the middle using a thin kerf bandsaw leaving two pieces of approximately 145×21 mm (see steps 1 and 2 of FIG. 6).

The boards were finally machine dressed on four sides to approximately 140×18 mm decking. The finished product was installed outside at the applicant's test site for 6 months

### Assessment of Timber

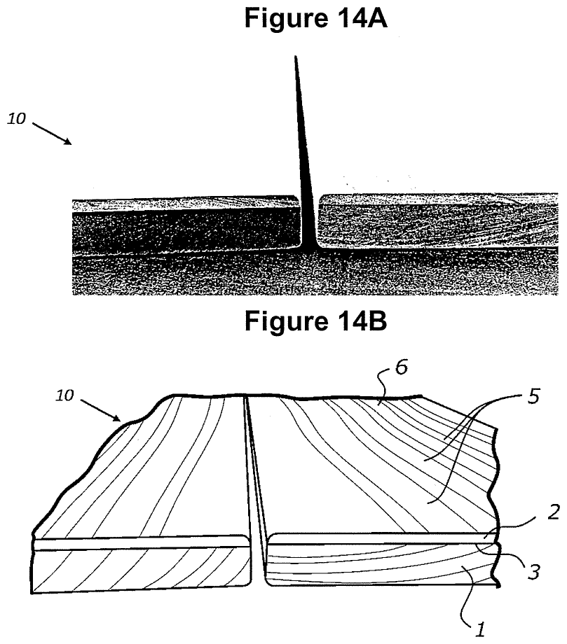

The laminated acetylated thermally modified top veneer showed no signs of face cracking, whereas the thermally modified flat sawn pine base material was beginning to crack (FIG. 14A, 14B, 15A and 15B).

### Example 7—Resin Impregnated Radiata Pine Veneer Onto Thermally Modified Pine Substrate

Flat sawn dressing grade radiata pine in 100×35 mm rough sawn dimension was thermally modified. The thermal modification was carried out at a temperature of about 230° C. The thermally modified pine was then machined to approximately 90×32 mm and cut to remove defects and create clear grade shook of 180 mm-400 mm length using a snip saw. The timber shook was then finger jointed with polyurethane adhesive into the joins.

The 90×32 mm boards were then split down the thickness of the board using a thin kerf bandsaw into approximately 90×15 mm boards.

Radiata pine of 100×32 dimension was thermally modified at 230° C. The timber was then pressure impregnated with a mix of melamine resin plus fire retardant in a pressure vessel. The timber was then dried in a kiln for around 10 days.

The impregnated timber was cut to 90×14 mm dimension and was placed between two pieces of 90×15 thermally modified radiata pine and was face laminated using phenol formaldehyde adhesive.

Once the adhesive was fully cured, the laminated timber block was split down the middle using a thin kerf bandsaw leaving two pieces of approximately 90×21 mm (see steps 1 and 2 of FIG. 6).

The boards were finally machine dressed on four sides to approximately 90××20 mm. The finished product was installed outside at the applicant's test site for 1 year

### Assessment of Timber

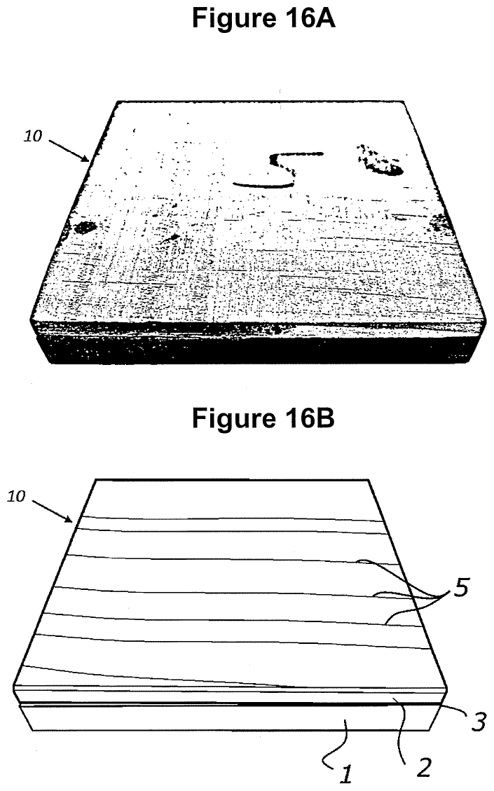

The resin impregnated pine veneer showed no signs of surface cracking (see FIG. 16A, 16B, 17A and 17B).

### Example 8—Laminated Vertical Grain Thermally Modified Radiata Pine Veneer Onto Thermally Modified Pine Cross Laminated Timber Substrate

Flat sawn dressing grade radiata pine in 150×32 mm rough sawn dimension was thermally modified. The thermal modification was carried out at a temperature of about 230° C. The 150×32 mm boards were then split down the thickness of the board using a thin kerf bandsaw machined into approximately 145×6 mm boards. The timber was then cut to length with a snip saw.

Two layers of flat sawn boards were combined together with a top layer of band sawn face thermally modified radiata pine laminated with vertical grain orientation of approximately 140×5 mm dimension. The boards were face glued using melamine adhesive in a three-layer construction. The middle layer was positioned at 90 degrees to the top and bottom layers to form a cross laminated timber panel. The panels were cured under pressure in a cold press.

The boards were finally machine dressed to approximately 140×18 mm cladding. The finished product was installed outside at the applicant's test site for 3 months.

### Assessment of Timber

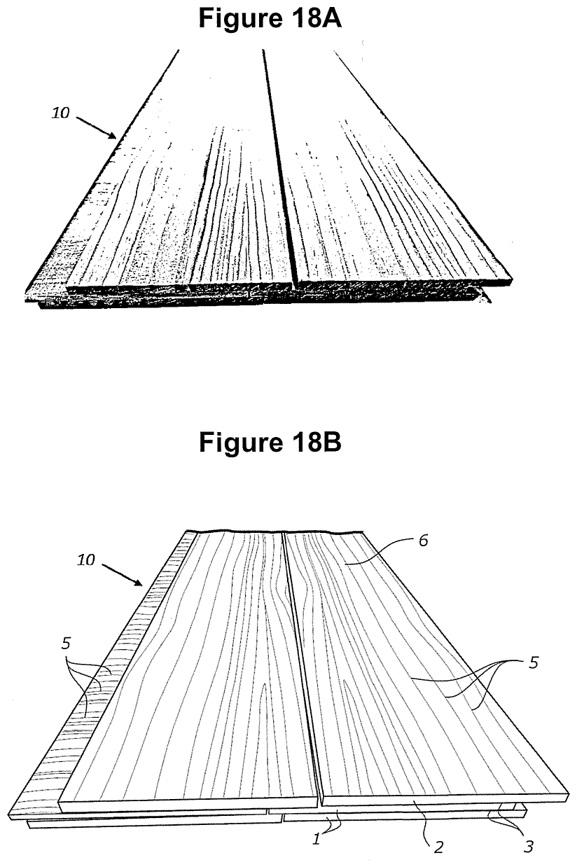

The laminated vertical grain thermally modified radiata pine veneer showed reduced signs of surface checking/cracking (see FIG. 18A and B).

In each of the examples a laminated timber product was produced that had a facing surface of high performance veneer that weathered extremely well, whilst having a dimensionally stable substrate timber. The resulting product appeared when installed to be a timber product of solid high-performance wood, yet was manufactured to a lower cost that if it has been made entirely from the high performance veneer timber.

1. A method of manufacturing high durability timber product, the method comprising:
a) selecting a durable substrate timber;
b) selecting a veneer of high-performance timber; and
c) gluing the veneer of high-performance timber to the face of the durable substrate timber,
wherein the resulting manufactured high durability timber product is suitable for long-term use in exterior applications at a lower cost than that of the same thickness timber product if made of high-performance timber alone.

2. The method of claim 1 wherein the durable substrate timber is stable and durable in exterior use.

3. The method of claim 1 or 2 wherein the durable substrate timber is flat sawn or rotary peeled timber.

4. The method of any one of the preceding claims wherein the durable substrate timber is dressing grade, merchantable grade, or standard grade.

5. The method of any one of the preceding claims wherein the substrate timber is a naturally durable timber such as eucalyptus, western red cedar, yellow cedar, larch, teak or other timber with minimum Class 3 durability (EN350) or equivalent.

6. The method of any one of claims 1 to 5 wherein the substrate timber is a non-durable timber such as Pinus species (pine), Douglas fir, poplar, or rubber wood that has been thermally modified.

7. The method of claim 6 wherein the substrate timber is thermally modified with or without preservative treatment.

8. The method of any one of the preceding claims wherein the substrate timber is preservative treated or modified for durability.

9. The method of claim 8 wherein the substrate is non-durable timber such as Pinus species, Douglas fir, poplar, or rubber wood that is treated with a preservative selected from Light Organic Solvent Preservative (LOSP), Copper Quaternary, Alkaline copper quaternary (ACQ), Chromated copper arsenate (CCA) minimum UC3A (American Wood Protection Association—AWPA), water based azoles, insecticides, water repellent, Micronized Copper Azole (MCA), copper naphthenate or equivalent.

10. The method of any one of the preceding claims wherein the construction of the durable substrate is solid, finger-jointed, laminated, plywood, cross laminated, laminated veneer lumber (LVL), board, panel or post.

11. The method of any one of the preceding claims wherein the veneer of high-performance timber is a stable and/or durable timber that is unlikely to crack in exterior conditions.

12. The method of any one of the preceding claims wherein the veneer of high-performance timber comprises stable naturally durable timber such as western red cedar, eucalyptus, kwila/merbau, teak, Cypress, Paulownia, thermally modified oak, thermally modified beech, spotted gum and thermally modified ash.

13. The method of any one of the preceding claims wherein the veneer of high-performance timber comprises substantially vertical grain timber or is laminated with substantially vertical grain orientation so that the veneer has the appearance of a vertical grain on the face of timber but is made from substantially flat grain timber.

14. The method of claim 13 wherein the veneer of high-performance timber is quarter sawn substantially vertical grain timber.

15. The method of any one of the preceding claims wherein the veneer of high-performance timber is Pinus radiata.

16. The method of any one of the preceding claims wherein the veneer of high-performance timber comprises a non-durable timber such as Pinus species, Spruce, Beech, Ash, Douglas Fir, Rubberwood, Poplar, Cedar, Cork that has been modified to increase its stability, durability and performance in exterior conditions.

17. The method of claim 16 wherein the veneer of high-performance timber comprises a modification selected from: thermal modification, densification, thermo-mechanical densification, acetylation, furfylation, resin impregnation, Dimethyloldihydroxyethelenurea (DMDHEU) modification, alkaline copper quaternary (ACQ) modification, copper azole treatment and/or combinations thereof.

18. The method of any one of the preceding claims wherein the veneer of high-performance timber is thermally modified.

19. The method of any one of the preceding claims wherein the veneer of high-performance timber is thermally modified substantially vertical grain Pinus radiata, thermally modified Pinus radiata timber laminated with substantially vertical grain orientation or thermally modified acetylated Pinus radiata.

20. The method of any one of the preceding claims wherein the veneer of high-performance timber is further treated with a preservative selected from LOSP, a solvent or water borne azole and/or an insecticide such as synthetic pyrethroids, neonicotinoids or boron.

21. The method of any one of the preceding claims wherein the veneer of high-performance timber is resistant to fire, with a minimum ASTM E84 Class A, AS3959 BAL29 (Australian Standard 3959), and/or EN 13501-1 Euro Class B (European Standard 13501-1).

22. The method of any one of the preceding claims wherein the veneer of high-performance timber has a thickness of about 1 mm to 10 mm. Preferably, the veneer has a thickness of about 1 mm, 1.5 mm, 2 mm, 2.5 mm, 3 mm, 3.5 mm, 4 mm, 4.5 mm, 5 mm, 5.5 mm, 6 mm, 6.5 mm, 7 mm, 7.5 mm 8 mm, 9 mm or 10 mm.

23. The method of any one of the preceding claims wherein:
the substrate is thermally modified radiata pine and the veneer of high-performance timber is acetylated radiata pine;
the substrate is thermally modified pine plywood and the veneer of high-performance timber is thermally modified vertical grain wood, thermally modified radiata pine laminated with vertical grain orientation, macrocarpa, spotted gum, eucalyptus, resin impregnated radiata pine or vertical grain western red cedar;
the substrate is CCA treated radiata pine posts and the veneer of high-performance timber is thermally modified radiata pine laminated with vertical grain orientation;
the substrate is a thermally modified radiata pine exterior grade plywood panel and the veneer of high-performance timber is thermally modified radiata pine laminated with vertical grain orientation;
the substrate is ACQ treated radiata pine laminated veneer lumber and the veneer of high-performance timber is ACQ treated kiln dried quarter sawn radiata pine;
the substrate is thermally modified flat sawn dressing grade radiata pine and the veneer of high-performance timber is thermally modified acetylated radiata pine;
the substrate is thermally modified flat sawn dressing grade radiata pine and the veneer of high-performance timber is resin impregnated radiata pine;
the substrate is thermally modified flat sawn dressing grade radiata pine cross laminated and the veneer of high-performance timber is band sawn thermally modified radiata pine laminated with vertical grain orientation; or
the substrate is thermally modified radiata pine and the veneer of high-performance timber is vertical grain cedar.

24. The method of any one of the preceding claims wherein the veneer of high-performance timber and/or substrate is further coloured by UV stable pigments imparted to the timber surface by pressure impregnation, spray or dip either on its own or as part of a preservative treatment process.

25. The method of any one of the preceding claims wherein the method comprises laminating a veneer of high-performance timber of 1 mm to 10 mm thick to the face of a predominantly flat sawn or rotary peeled pine substrate.

26. The method of any one of the preceding claims wherein the veneer of high-performance timber is laminated to the face of solid, finger-jointed, laminated, plywood, cross-laminated or laminated veneer lumber (LVL) substrate timber.

27. The method of any one of the preceding claims wherein the veneer of high-performance timber is laminated to the face of a board, panel, beam or post substrate timber.

28. The method of any one of the preceding claims wherein the timber product is cross-laminated.

29. The method of claim 28 wherein the high durability timber product comprises three layers: a top veneer of high-performance timber layer and two layers of substrate, wherein the middle substrate layer is positioned at 90 degrees to the top veneer layer and the bottom substrate layer to form a cross laminated timber.

30. The method of any one of the preceding claims wherein the veneer of high-performance timber is glued to the substrate using a high-performance exterior-type glue, selected from as polyurethane, melamine, melamine urea, phenolic and/or resorcinol adhesives.

31. A timber product suitable for exterior application produced by the method of any one of claims 1 to 30.

32. A manufactured timber product comprising a veneer and a substrate wherein:
a. the substrate is a durable substrate timber cut by flat saw or rotary peel;
b. the veneer is a high-performance timber that is unlikely to crack in exterior conditions; and
c. the veneer is glued to the face of the substrate,
wherein the resulting timber product is suitable for long-term use in exterior applications at a lower cost than that of the same thickness timber product if made of high-performance timber alone.

33. The timber product of claim 31 or 32 suitable for end use application as weatherboard cladding, shiplap, tongue and groove, square dressed, rhombus, decking or screening.

34. The timber product of claim 31 or 32 wherein the product is a board, panel, beam or post.

35. The timber product of claim 31 or 32, wherein the timber product is a cladding or decking board of about 70-290×20-32 mm or a panel of about 15-25 mm thick×600-1200 mm width×2400-6000 mm length.

36. The timber product of claim 31 or 32, wherein the timber product comprises band sawn, brushed, textured or smooth dressed faces.

37. The method of any one of claims 1 to 30 comprising a further step of treating the timber after gluing with a modification selected from resin impregnation, furfylation, acetylation, or preservative treatment.

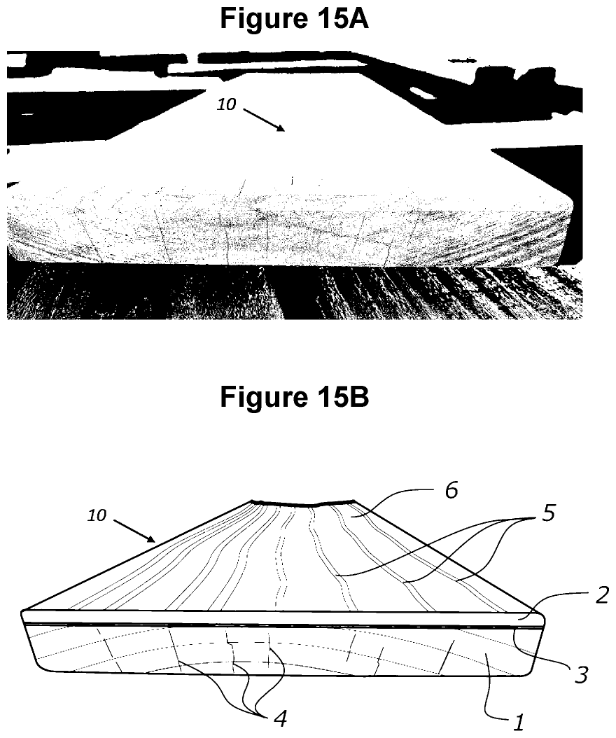

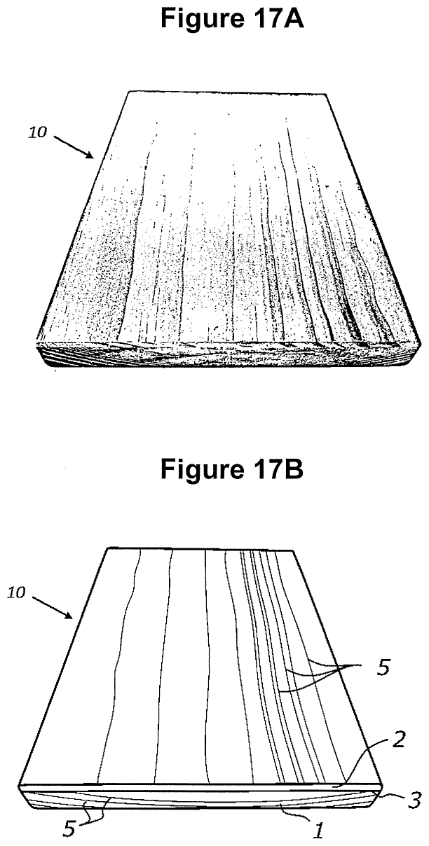

38. A high durability timber product comprising a durable substrate timber and a veneer of high-performance timber, as described with reference to any one of FIGS. 5 or 7 to 18.
